(19) United States
(12) Patent Application Publication
(10) Pub. No.: US 2004/0128034 A1
(43) Pub. Date: Jul. 1, 2004

(54) Method and apparatus for water flow sensing and control

(76) Inventors: Jay A. Lenker, Laguna Beach, CA (US); James A. Carroll, Long Beach, CA (US); Karen J. Lenkor, Laguna Beach, CA (US); Cynthia Carroll, Long Beach, CA (US)

Correspondence Address: Jay A. Lenker, 408 Panorama Drive, Laguna Beach, CA, 92651, US

(21) Appl. No.: 10/735,329

(22) Filed: Dec. 11, 2003

Related U.S. Application Data
(60) Provisional application No. 60/432,458, filed on Dec. 11, 2002.

(51) Int. Cl. G05D 7/00

(52) U.S. Cl. 700/282

(57) ABSTRACT

This invention relates to water or liquid flow detection or sensing systems that are further capable of actively controlling the flow of the water or other liquid that is being sensed.

The invention uses a microphone or other acoustic sensor to detect the acoustic signature of liquid flow through a pipe. Water or liquid flowing through a pipe or a system of pipes generates an acoustic signature that can be detected, measured, and analyzed. Based on the analysis of the acoustic signature of the liquid flow, a determination is made whether a fault or leak in the line has occurred. If a determination is made that a fault has occurred, a water shutoff valve is activated ceasing the flow of water or other liquid. The system further includes audible and visual warning devices to indicate whether a fault has occurred as well as general system status. The system is configured to control the water main leading into a building or it is configured to control the water leading into a specific hose or appliance such as a toilet or washing machine. The whole building system uses a computer to analyze the acoustic signatures detectable in the house and can determine if one of these signatures has been occurring for a time period outside an acceptable limit and determining that a fault has occurred.

### RELATED APPLICATIONS

The present application claims priority benefit under 35 USC § 119(e) from U.S. Provisional Application No. 60/432,458 filed Dec. 11, 2002, entitled “METHOD AND APPARATUS FOR WATER FLOW SENSING AND CONTROL”, which is herein incorporated by reference.

### FIELD OF THE INVENTION

This invention relates to devices and methods for detecting or sensing the flow of water and using that information to control a water valve.

### BACKGROUND OF THE INVENTION

Homeowners' insurance costs are rising rapidly. One of the reasons cited by insurance companies for the insurance cost rise is the proliferation of water leaks in homes and businesses. As structures age, the water pipes or hoses deteriorate and may rupture due to an inability to resist internal water pressure. Foundations, especially slab foundations found in many homes, may crack and water supply pipes routed through the concrete foundation may become damaged and leak. Water leakage can lead to significant damage to the home or office and its contents. A hose leading to a washing machine could leak spilling significant amounts of water into a home. In 1989, based on personal experience, a water leak from a washing machine hose that lasted for about two hours caused in excess of $8,000 damage to a home. According to the insurance adjustor, an eight-hour leak in a neighboring town was responsible for damage approximating $100,000. Today, concerns over toxic mold and its propagation in the area affected by a water leak is cited as a major reason for causing cleanup costs for a water leak to skyrocket. Litigation relating to such toxic mold buildup is on the rise and the legal costs of such a scenario are extremely high.

Most all homes and businesses have manual water shutoff valves. These valves are used to curtail water service to the building or structure once a leak has been detected or a repair is required. A water leak often goes unnoticed, however, until significant damage has occurred. Thus, a manual water valve is not adequate to control the spillage of water into the environs of the building. Prior art devices have been disclosed which will monitor and shut off the flow of water to a single faucet, spigot or appliance. These devices are unable to monitor an entire house or building because of the complexity of the water flow requirements to such buildings.

New devices, systems and methods are needed to automatically shut off water flow into a building or structure when a leak occurs. Such devices are particularly important in the current environment where homeowners, renters, or corporate facility insurance costs are spiraling out of hand.

### SUMMARY OF THE INVENTION

This invention relates to devices and methods for sensing the flow of water or other liquid. Using the information derived from the liquid flow sensing apparatus, an active or powered liquid shutoff valve can be triggered to stop the flow of liquid into the structure until the leak can be corrected. The potential cost savings of such a system are enormous when control of water sources into a building or house are considered.

The invention is an automatic liquid flow sensor and control valve further comprising: a length of pipe through which liquid flows, an acoustic sensor, a clock, a data storage system, an optional audio or visual function display device, a logic controller, suitable software, and a power supply. For the purposes of this disclosure, the invention will heretofore be called an Acoustic Valve.

There are two primary occasions when such a liquid flow control and sensing device is necessary. First, a water hose break to a washing machine, refrigerator, toilet, sink, water softener, or other fixture or appliance could be sensed and specifically curtailed with such a device. Second, the entire home or building could be monitored for water flow patterns and abnormal patterns or signatures of water flow used to shut off the entire water main to the building. Secondary applications for the technology are plentiful as they occur, for example, in the military, research, industrial, and aerospace sectors.

The acoustic valve system, configured to work in the situation of a single appliance is as follows: The device is mounted in-line to the hose at the manual water shutoff valve, typically on the interior wall of the building behind the appliance or fixture. The device is threaded onto the manual water valve and the hose is threaded onto a fixture connected to the device. The device is house current with battery backup or battery powered and monitors the sound emanating from the water pipe by way of a microphone or other acoustic sensor. The device analyzes the frequency spectrum of the sound using a Fast Fourier Transform (FFT) and determines whether the spectrum is abnormal or whether the water flow is occurring continuously for too long a time. If a positive determination is made, a motor-controlled ball valve, gate, or other type of valve is activated to shut off the water flow to the hose. At the same time, an audible signal, a visual signal, a radio signal, an infrared signal, a microwave signal or other wireless signal would be generated to notify the occupants of the structure or alarm company that the fault has occurred.

The device can also be triggered manually by pressing a button, throwing a switch, by voice command, by RF, microwave, infrared, ultrasonic, computer generated, internet-based, local area network based, or other remote control activation system.

The power supply for the acoustic valve is a battery or house current. The battery is, preferably, a rechargeable battery comprising chemistries such as, but not limited to nickel cadmium, lithium ion, nickel metal hydride and the like. The battery may also be a non-rechargeable battery such as certain lithium chemistries and alkaline chemistries. The house current is typically 60 Hz alternating current (AC) and the voltage ranges from 110 VAC to 440 VAC. European systems run on 50 Hz 220 VAC or 240 VAC. House current with battery backup is the preferred power supply for the system.

The acoustic valve system, configured to function as the water main sentry is as follows: The outflow of the acoustic valve is affixed to the inflow water pipe of the building or structure, preferably at or near the building where access is optimal. Preferably, the acoustic valve system is plugged into the building's electrical outlet. The acoustic valve system also includes a battery backup for times when house power is turned off. A microphone or other sensor for acoustic waves is affixed to a pipe or other structure internal to the acoustic valve. The microphone detects the acoustic patterns of the pipe. Because of differences in pipe lengths, type of leak, etc., each leak or water flow outlet in the house will generate its own acoustic signature. A logic controller, further comprising memory, a clock, and a central processing unit (CPU), analyzes the acoustic signal to determine the frequencies, amplitude and frequency spectrum over time. A Fast Fourier Transform (FFT) is a preferred analytical algorithm. A frequency spectrum often provides signature information regarding the source of the spectrum and allows a discriminator program to determine whether the source is continuing to contribute to the spectrum or whether that source has been turned off. If the frequency spectrum is unchanged over a specified time, deemed by the controller to be indicative of a leak, the logic controller sends a signal to the valve controller causing a water valve to close. Preferred valve types include, but are not limited to, ball valves, gate valves, needle valves, and the like. The valves are operated by devices such as, but not limited to, electric motors, geared electric motors, pneumatic actuators, hydraulic actuators, springs, and the like.

The exact algorithm for analyzing the flow of liquid need not be determined ahead of time. It is desirable to “train” the system to memorize normal patterns of acoustic signature, which relate to normal patterns of liquid flow for a given structure or building. Frequency and amplitude information is gathered during the training cycle and during the monitoring cycle. Once trained, the acoustic valve stores this pattern in memory and compares future acoustic patterns to the training pattern. If the water valve, at a future time, detects an anomalous pattern in the acoustic signature, the valve shuts off flow to the building until such time as human intervention determines that there is not a problem, or until the problem is detected and corrected. Such training should occur over periods-of-time such as one day, one week, or one month. This type of analysis is within the scope of the current state of the art in computer technology. The degree of deviation between the measured pattern and the trained pattern is such that a high confidence is placed on the determination of deviation. Thus, false positive activations are minimized. Another way of triggering activation of the system is the detection of a frequency component corresponding to a specific rate of liquid flow among the other acoustic patterns. The presence of this frequency component existing for periods of time in excess of 30 minutes without change would indicate an unwanted water flow situation and activation of the valve closure mechanism would occur. In one embodiment, neural network system is appropriate for a training system. A rule-based system is an appropriate system in another embodiment.

In cases where the acoustic valve is in a low flow region or where the acoustic signature is weak, an additional component is added to the system. A reed is placed within the pipe of the water valve. This reed vibrates at a frequency, which varies with the rate of liquid flow. It is not necessary to correlate the frequency with the flow rate, it is just necessary that a given liquid flow rate correspond to a given acoustic frequency. Otherwise, it is possible to calibrate the frequency versus flow rate of the system.

The acoustic valve may have identification so that its location can be transmitted to an external receiver. Such identification may be a serial number or it may actually identify the exact street address, and room location of the acoustic valve.

A primary advantage of the acoustic water valve is that it has no continually moving parts that could wear or break. The system is largely solid-state. The acoustic water valve is capable of adapting to the changing needs of water or liquid usage. A flowmeter driven system uses propellers or other devices to measure flow rate but such a system cannot detect the signatures of certain appliances or systems (such as garden sprinklers) as well as can the acoustic water valve.

For purposes of summarizing the invention, certain aspects, advantages and novel features of the invention are described herein. It is to be understood that not necessarily all such advantages may be achieved in accordance with any particular embodiment of the invention. Thus, for example, those skilled in the art will recognize that the invention may be embodied or carried out in a manner that achieves one advantage or group of advantages as taught herein without necessarily achieving other advantages as may be taught or suggested herein.

These and other objects and advantages of the present invention will be more apparent from the following description taken in conjunction with the accompanying drawings.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention. Throughout the drawings, reference numbers are re-used to indicate correspondence between referenced elements.

FIG. 1 illustrates a block diagram of an acoustic valve configured for attachment between a water source and a water demand, according to aspects of an embodiment of the invention;

FIG. 2 illustrates an acoustic water valve in line with a washing machine, according to aspects of an embodiment of the invention;

FIG. 3 illustrates and acoustic water valve as a sentry on the main water line into a house, according to aspects of an embodiment of the invention;

FIG. 4 illustrates an acoustic generator, according to aspects of an embodiment of the invention;

FIG. 5A illustrates an acoustic pattern for a normal water flow to a washing machine for a single cycle, according to aspects of an embodiment of the invention;

FIG. 5B illustrates an acoustic pattern indicative of a water leak in the line leading to a washing machine, according to aspects of an embodiment of the invention;

FIG. 6A illustrates an acoustic pattern comprising two water flow acoustic signatures, according to aspects of an embodiment of the invention;

FIG. 6B illustrates the acoustic pattern of FIG. 6A wherein the larger amplitude higher frequency acoustic signature has stopped and is no longer displayed, according to aspects of an embodiment of the invention.

### DETAILED DESCRIPTION OF THE INVENTION

The present invention may be embodied in other specific forms without departing from its spirit or essential characteristics. The described embodiments are to be considered in all respects only as illustrative and not restrictive. The scope of the invention is therefore indicated by the appended claims rather than the foregoing description. All changes that come within the meaning and range of equivalency of the claims are to be embraced within their scope.

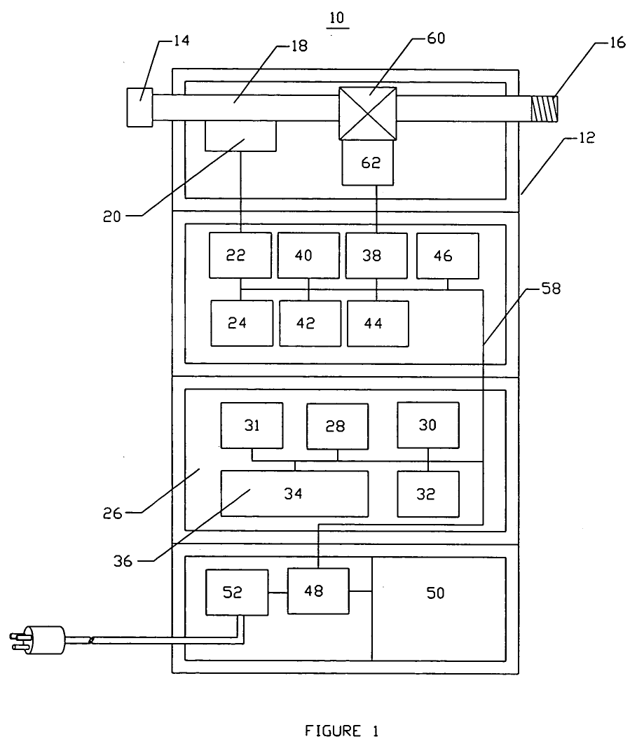

FIG. 1 illustrates a block diagram of an acoustic water valve 10. The acoustic water valve 10 further comprises a case 12, an inlet port 14, an outlet port 16, an internal conduit 18, an acoustic sensor 20, a sensor signal processor 22, an analog to digital (A-D) converter 24, a logic controller 26, further comprising a CPU 28, memory 30, a clock 31, support electronics 32, long-term storage memory 34, and software 36. The acoustic water valve 10 further comprises a valve drive controller 38, an audio output device 40, a visual output device 42, communications link 44, a manual input device 46, a power supply 48, a battery 50, an AC-DC power converter 52, a power line 54, an electrical plug 56, a system bus 58, a liquid valve 60 and a valve drive 62.

Referring to FIG. 1, the acoustic water valve 10 is physically attached to a source of liquid by the inlet port 14. The outlet port 16 is physically connected to the pipe feeding the liquid demand. The inlet port 14 and the outlet port 16 are physically affixed to the ends of the internal conduit 18. The internal lumens of the inlet port 14, the internal conduit 18, and the outlet port 16 are in communication so that liquid flows through from the inlet port 14 to the outlet port 16 in a relatively unrestricted manner. The acoustic sensor 20 is rigidly affixed to the side of the internal conduit 18. The acoustic sensor 20 is electrically connected to the sensor signal processor 22. The output of the sensor signal processor 22 is electrically connected to the A-D converter 24, the output of which is electrically connected to an input of the logic controller 26. The logic controller components including the CPU 28, the memory 30, the clock 31, the support electronics 32, and the long-term storage memory 34 are electrically interconnected via the system bus 58. The software 36 resides within long-term storage memory 34 or resides in firmware (not shown). The valve drive controller 38 is electrically connected to an output of the logic controller 26. The audio output device 40 and the visual output device 42, as well as the communications link 44 and the manual input device 46 are, each, electrically connected to the logic controller 26 by the system bus 58. The power line 54 is electrically connected to the electrical plug 56 at one end and the AC-DC converter 52 at its other end. The AC-DC converter 52 is electrically connected to the battery 50, which is further electrically connected to the input of the power supply 48. The valve drive controller 38 is electrically connected to the valve drive 62. The valve drive 62 is mechanically engaged to the valve 60 so that the valve drive 62 causes the valve 60 to open and close. All components of the acoustic water valve 10 are physically affixed to a chassis (not shown), which is further encapsulated by the case 12.

Further referring to FIG. 1, the acoustic sensor 20 is, for example, a microphone, piezoelectric sensor, piezoresistive sensor or other device or transducer capable of detecting acoustic waves and converting said acoustic waves into electrical signals or electrical properties such as resistivity, capacitance, for example. The acoustic sensor 20 is affixed to the through conduit 18 and detects acoustic or sound vibrations in the internal conduit 18 that have been transferred there through the liquid being carried by the through conduit 18. The acoustic transducer or sensor 20 preferably continuously monitors the acoustic patterns generated in the through conduit 18. The sensor signal processor 22 is, for example, a Wheatstone bridge and amplifier capable of generating a variable voltage output as a function of acoustic amplitude. Any other appropriate signal processor 22 capable of generating the required output from the signal received from the acoustic sensor 20 is appropriate for this application. The Analog to Digital converter 24 receives an analog signal from the sensor signal processor 22 and generates a digital output capable; of being used by the logic controller 26.

The logic controller 26 may be any computer circuit, capable of performing the required signal input, signal analysis, and output of the required signal to the valve drive controller 38 as well as any other devices such as the audio output device 40, visual output device 42, and communications link 44. The software 36 is retained in long-term memory 34 or it is retained in an EPROM or other permanent memory device such as, but not limited to, a magnetic hard drive, optical drive, or read only memory (ROM). The logic controller 26 preferably comprises random access memory 30, a clock 31, a central processing unit 28, the system bus 58, and support electronics 32, although any computer circuit capable of performing the job is appropriate in this situation.

The audio output device 40 is preferably, a small loudspeaker or sound generator coupled to an appropriate frequency generator and amplifier. The audio output device 40 is capable of generating a continuous tone, modulated tone or recognizable speech indicating the status of the acoustic valve 10 and the nature of a shutoff activation, if any. The audio or sound output is loud enough to be heard at a distance of at least 10 feet and up to 100 feet away.

The visual output device 42 is a LED, light bulb, LCD display, TFT active matrix display, or other device that notifies a person of the status of the acoustic valve 10 and the nature of a shutoff activation event, if any. The display may be a simple green LED indicating system normal. Indication of valve shutoff activation would be a simple red LED that illuminates either continuously or flashes to get the attention of the user. The visual output device 42 may also be an alphanumeric display that provides full system information in a complete, scrolling, or cyclic manner.

The communications link 44 is preferably a radio frequency device that makes a telephone call over the wireless or ground line telephone services to a telephone receiver at a monitoring station such as is used for theft, fire, or other alarms. In yet another embodiment, the communications link 44 makes a telephone call to the telephone number of the residence using the telephone ringer as an alarm and notifying the occupant of the building or leaving a message on the answering machine. The communications link 44 sends an intelligible audio transmission in the language appropriate to the country where the acoustic water valve 10 is installed, stating the type of event, the time, and the location of the acoustic water valve 10. The location information is input the acoustic water valve at the time of setup or it is taken from a Global Positioning System (GPS) electrically connected to the logic controller 26. The time information is taken from the clock 31. An example of the transmission is: “Potential water leak detected at 4:30 PM at 123 Main Street, Los Angeles, Calif., Water Main to house shut off”. In another embodiment, the communications link 44 is an Ethernet or other connection to a local area computer network or it is a connection to a wide area network such as the Internet. The wide area network connection is digital and is made through systems such as, but not limited to, cable modem, DSL modem, standard telephone modem, satellite modem, or the like. In yet another embodiment, the communications link 44 is a microwave, infrared, radio frequency, ultrasonic, or other wireless system that sends a signal to a local receiver, within the building where the acoustic water valve 10 resides. The receiver is enabled with an alarm or it is connected to the building central alarm system. The wire-type communications link 44 operates over telephone lines, 110 VAC or 220 VAC electrical building wiring or any other available electrical lines.

The system clock 31 is a standard digital device and optionally receives updated time information over the communications link 44. The clock 31 is used to operate the logic controller 36 and to analyze the frequency spectrum of liquid flow acoustic signature.

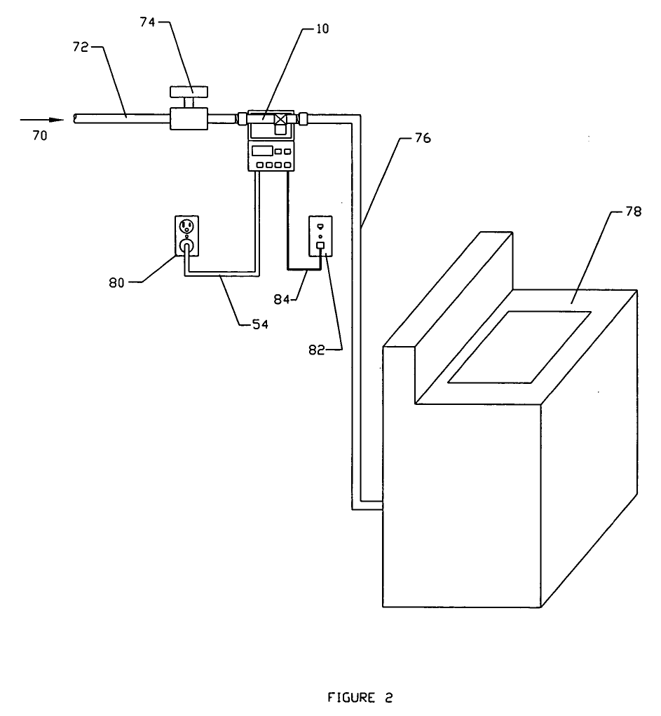

FIG. 2 illustrates an acoustic water valve 10 in line with a washing machine 78. The water 70 supply to the washing machine 78 is routed through pipe 72 and through manual shutoff valve 74. The inlet of the acoustic water valve 10 is threaded onto the outlet of the manual shutoff valve 74. The washing machine hose 76 is threaded onto the outlet of the acoustic water valve 10. The outlet end of the washing machine hose 76 is threaded onto the inlet fitting of the washing machine 78. Electrical power to the acoustic water valve 10 is optionally derived through an electrical outlet 80 and routed to the water valve through the power line 54. Referring to FIG. 1 and FIG. 2, the telephone jack 82 near the acoustic water valve serves optionally to transmit information from the communications link 44 of the acoustic water valve 10 through the telephone cord 84.

Referring to FIG. 2, should a leak occur in the washing machine hose 76, a common occurrence, the acoustic water valve 10 senses that the normal water flow patterns are not occurring and shuts off the flow of water 70 to the hose 76. A typical algorithm for such an acoustic water valve 10 is that if water flow is detected for longer than 15 minutes without stopping, the water 70 flow will be shut off by the acoustic water valve 10. The range of times to trip the shutoff is between 5 minutes and 120 minutes. Preferably, the range of times to shutoff the acoustic water valve 10 will range between 10 minutes and 60 minutes. For other appliances such as an icemaker or toilet, the acoustic water valve will monitor for changes to occur in different lengths of time but in no event should water flow continuously for a time outside the cited range for the single appliance or hose valve. A lawn sprinkler system may require a longer range of times before shutoff occurs depending on the amount of lawn to be watered, the number of sprinkler heads, valves, etc. The acoustic water valve 10, in the case of the sprinkler system would also monitor for water flow rate spikes or dips. The lack of dips during 1.5× to ten times the specified time for a single sprinkler valve indicates lack of normal operation and would trigger a shutoff event. For example, a sprinkler system has four valves and waters four zones. Each zone is watered for 15 minutes with a total watering time of approximately 60 minutes. An eight valve or eight zone system would run for two hours if each zone operated for 15 minutes. When one valve shuts off and another valve opens up, the water flow rate stops or diminishes. This is a sign of proper operation. If the water flow rate dip does not occur within 22.5 to 30 minutes, the acoustic valve 10 will activate a shutoff sequence.

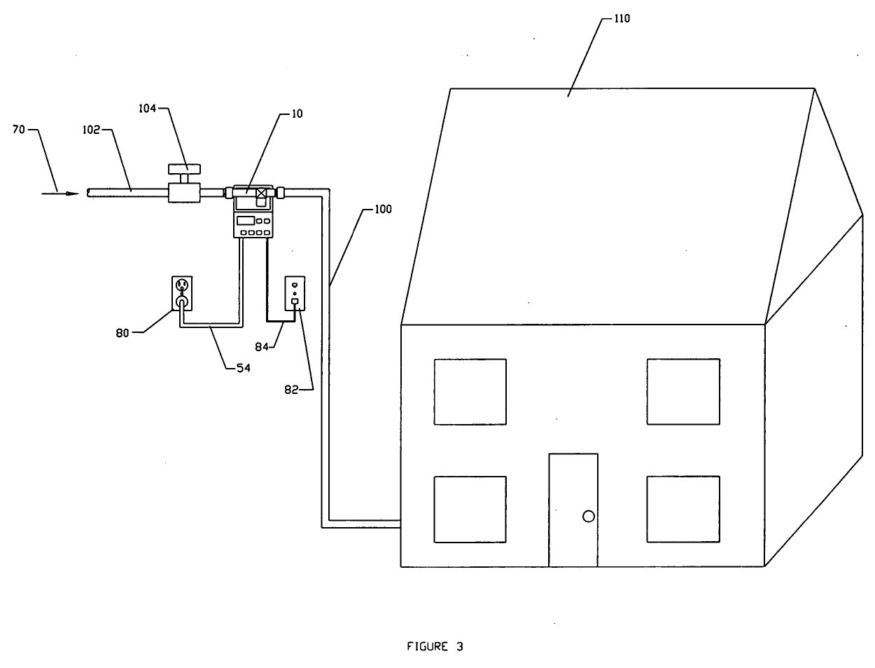

FIG. 3 illustrates an acoustic water valve 10 in line with a house water main 100. The water 70 supply to a house water main 100 is routed through a house supply pipe 102 and through a manual shutoff valve 104. The inlet of the acoustic water valve 10 is threaded or soldered onto the outlet of the water main shutoff valve 104. The house water main 100 is threaded or soldered onto the outlet of the acoustic water valve 10. The water main 100 supplies water to much or all of the house 110. Electrical power to the acoustic water valve 10 is optionally derived through an electrical outlet 80 and routed to the water valve through the power line 54. Referring to FIG. 1 and FIG. 3, the telephone jack 82 near the acoustic water valve 10 serves optionally to transmit information from the communications link 44 of the acoustic water valve 10 through the telephone cord 84. The telephone jack 82 and the electrical outlet 80 are preferably affixed to the house but they may also be mounted on fixtures remote from the house. The communications link 44 is optional and may optionally use a wireless transmission method. Therefore, the telephone jack 82 is not required in all cases. The electrical outlet 80 is not required if a battery only system is used.

The patterns of water flow in a house or building are more complex than to a single appliance like a washing machine. Referring to FIGS. 2 and 3, the acoustic water valve 10 is configured the same for a water main sentry as for a single appliance or hose sentry with the exception that the algorithm or software for monitoring the flow rate and activating shutoff is more complex. Although no single water usage should exceed, for example, 1 hour or ½ hour before shutting off, the overlapping usages of water from a water main may result in a situation where the water is not completely shut off for long periods of time. For example, a toilet flush, followed by a tub being filled, followed by the washing machine turning on, followed by the dishwasher, followed by the sprinkler system may lead to a long period of water flow, exceeding several hours. The on and off cycles of water usage for a given appliance or fixture may overlap. An absolute stop may be programmed in that requires total cessation of water flow every 1 to four hours. In addition, however, the program can detect the presence of a signature or component or pattern attributable to a given appliance. A signature outside that for any given appliance or a signature that continues for a given period of time beyond the specified limit will cause a water shutoff event to occur.

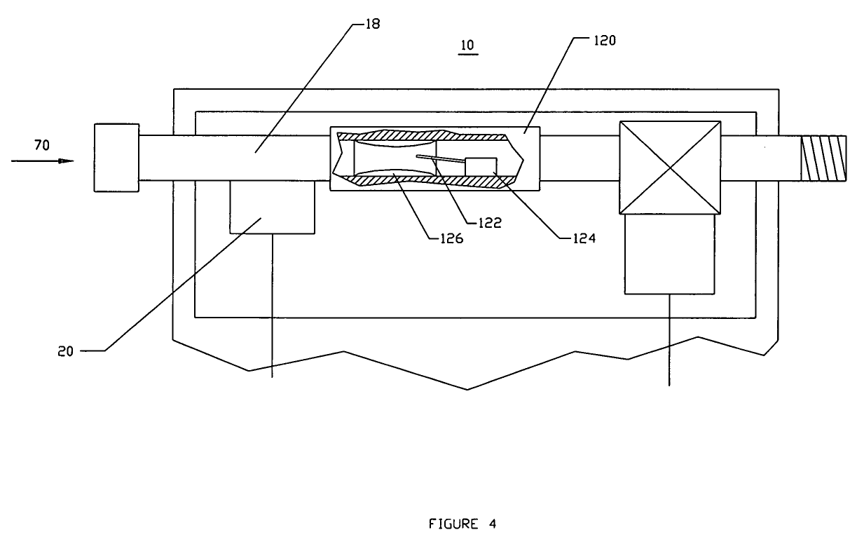

FIG. 4 illustrates an optional acoustic generator 120 affixed to the interior or inner lumen of the through pipe 18 of the acoustic water valve 10. The acoustic generator 120, shown with the exterior wall cut-away, comprises a thin reed 122 affixed to an elastic support 124 that permits the reed 122 to vibrate in a fluid 70 flow. The acoustic generator 120 optionally comprises a stenosis, narrowing or venturi 126 to accelerate the liquid flow past the reed 122. The reed may be affixed facing upstream or downstream in the fluid 70 flow. The faster the fluid 70 flows, the faster the reed 122 will vibrate. The reed 122 will vibrate due to vortex shedding off the back of the reed 122 generating an oscillation in pressure. Referring to FIGS. 1 and 4, the vibrations of the reed 122 are picked up by the acoustic sensor 20 of the acoustic water valve 10. This system is useful if the acoustic signature of water 70 or liquid flow is of insufficient amplitude to be sensed or measured by the acoustic sensor 20. In another embodiment, a plurality of reeds 122 is utilized because each reed may be tuned to different frequencies and, thus, widen the frequency range of the system.

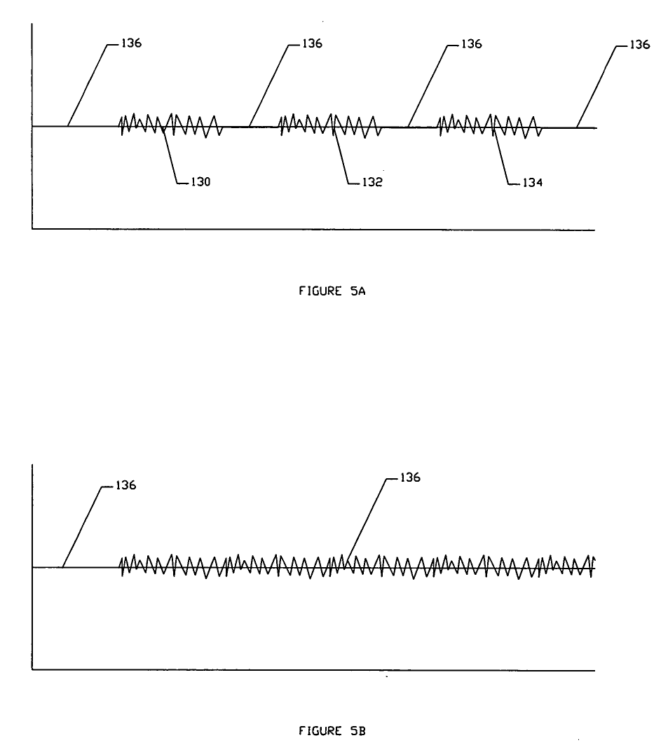

FIG. 5A illustrates an acoustic pattern for water flow to a washing machine under normal operating conditions. The acoustic pattern displays energy on the vertical axis and time on the horizontal axis. There are periods of acoustic energy when water flows separated by periods when water is not flowing into the washing machine. The acoustic pattern for washing lasts only ½ hour (range 10 minutes to 60 minutes) for the typical washing machine and is otherwise quiescent. Referring to FIG. 5A, the water flows for three periods of time. The first period 130 fills the washing machine for the washing cycle. The second period 132 fills the washing machine, after draining out the sudsy water, for a first rinse cycle. The third period 134 fills the washing machine, after draining out the water from the first rinse cycle, for the final rinse cycle. Periods of no water flow 136 exist between each of the filling periods as well as before and after the washing cycle.

FIG. 5B illustrates an acoustic pattern for water flow to a washing machine where a water leak has occurred in the line. The acoustic pattern displays energy on the vertical axis and time on the horizontal axis. The acoustic signature is different than during normal operation in that there are no changes in frequency, amplitude, or energy that occur and the acoustic signature does not stop after a long period of time. The period before the water line break is a time of no flow 136. A period of leakage 138 begins after the quiescent period 136 and continues to the end of the recording and beyond.

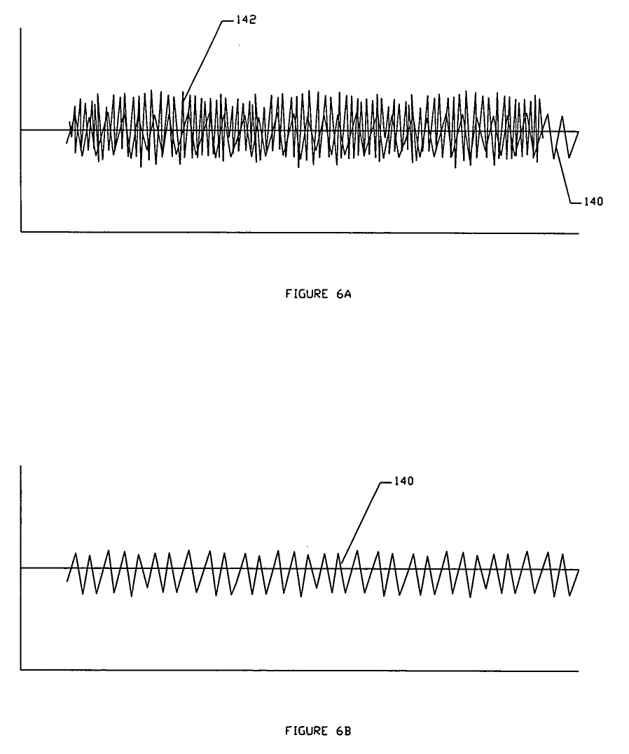

FIG. 6A illustrates an acoustic pattern for liquid flow in a branching pipe system. There are two outflow sources in the system and two acoustic signatures represented. The acoustic signature comprises a high amplitude, high frequency waveform 142 and a low frequency, low amplitude waveform 140. Such waveforms are indicative of flow through two exits in the system. Referring to FIGS. 1 and 6A, the acoustic water valve 10 is capable of identifying such plurality of waveforms and discriminating between such waveforms so that a single system can monitor many outflows within a building or structure.

FIG. 6B illustrates the acoustic pattern of FIG. 6A wherein the low frequency, low amplitude signal 140 is still present but the high frequency, high amplitude signal 142 has ceased or stopped. The stopping of a flow signal after a pre-determined or learned period of time indicates a normally functioning system with no unwanted leaks. The lack of such signal stopping after such a period of time could be indicative of an unwanted liquid flow or leak. Referring to FIGS. 1 and 6B, the acoustic water valve 10 can detect such cessation of liquid flow as evidenced by the discontinuation of the specific acoustic signal. A rule-based software system or neural network are preferred systems of analyzing such complex liquid flow patterns.

In another embodiment, the acoustic valve 10 is used as the sentry for a gas main. Gas shutoff valves are required when a gas leak occurs. Such gas leaks are problematic in many instances but during earthquakes, especially severe earthquakes, a large number of gas lines could rupture causing fire and significant destruction.

In another embodiment, the acoustic valve 10 utilizes an ultrasonic flowmeter to measure the rate of fluid flow instead of an acoustic transducer or sensor 20. In yet another embodiment, the flowmeter is of a type including, but not limited to, a rotary propeller or vane that spins faster as the flow increases, a venturi that further comprises pressure measurement components to determine pressure drop, a rotameter, a laser Dopper velocimeter, a coriolis acceleration meter, and the like. Standard flowmeters will require different algorithms to determine whether a leak has occurred but simplistic algorithms that require shutoff of flow periodically are preferred. Flow spectral analysis is also appropriate in this application.

In another embodiment, in addition to the previously described acoustic method for the sensing of water flow, a supplemental method and apparatus are presented here that may be utilized to inform the acoustic valve that a water flow (or usage) is authorized. This method and apparatus can be used in conjunction with the acoustic water flow sensing method. The system comprises an RF transmitting device installed on one or more water-using appliances, typically, one that uses an electric solenoid valve that is powered to cause water to flow to it. (This is typical of washing machines, dishwashers, ice machines, and others.) These are appliances, fixtures, faucets, etc. within the building or structure and are remote from the acoustic water valve 10. The transmitter is wired in parallel with the solenoid valve so that it transmits a signal whenever the solenoid is actuated. The signal identifies which device is using water and indicates the duration of the water usage. The signal is received by the main acoustic valve. The signals from various transmitters on various water-using devices inform the valve controller that (a portion of) the acoustically-sensed water flow is authorized. By coding the transmitted signals, it is possible for the acoustic valve to correlate or distinguish between different water-using devices. A user input defines a particular flow rate to each water-using appliance in the system. Thus, an authorized flow input to the acoustic valve controller may override a determination that a leak is occurring at a specific appliance or location.

The present invention may be embodied in other specific forms without departing from its spirit or essential characteristics. For example, the acoustic valve 10 may use acoustic waveforms generated by the plumbing system of the building and the liquid flowing through it, it may use an ultrasonic method of detecting liquid flow, or it may comprise a sonic generator whose amplitude or frequency varies with liquid flow rate. The acoustic water valve 10 may be used to monitor water flow rate or the flow of other types of liquid or fluid. The described embodiments are to be considered in all respects only as illustrative and not restrictive. The scope of the invention is therefore indicated by the appended claims rather than the foregoing description. All changes that come within the meaning and range of equivalency of the claims are to be embraced within their scope.

What is claimed is:

1. An apparatus adapted for detecting and stopping leaks in a liquid line comprising:
a liquid shutoff valve,
an activation mechanism for the liquid shutoff valve,
a logic controller,
an acoustic transducer, and
a software program to analyze the output of the acoustic transducer and close the liquid shutoff valve when conditions of a leak are detected,
wherein the apparatus monitors the flow of liquid at or near the entry point of a structure.

2. The apparatus of claim 1 wherein said apparatus further comprises a visual output device to announce the presence of a liquid shutoff event.

3. The apparatus of claim 1 wherein said apparatus further comprises an audio output device to announce the presence of a liquid shutoff event.

4. The apparatus of claim 1 wherein said apparatus further comprises a communications link to announce the presence of a liquid shutoff event.

5. A method of shutting off liquid flow in a main liquid inflow line to a building that has incurred a leak that involves the steps of:
Sensing the acoustic signature within the line,
Comparing the acoustic signature with pre-determined limit conditions, and
controlling a liquid shutoff valve in the line to cease liquid flow input to the main liquid inflow line should the acoustic signature indicate a leak anywhere in the system.

6. The method of claim 5 wherein a visual or audio signal is generated indicating the occurrence of the shutoff of the liquid line.

7. The method of claim 5 wherein a communications link transmits a signal indicating the occurrence of the shutoff of the liquid line.

8. The method of claim 5 wherein the line leads to a single appliance or fixture.

9. The method of claim 5 wherein the line leads into a water main line for a house or building.

10. An apparatus adapted for stopping leaks in a water line comprising:
an apparatus for sensing or monitoring the acoustic signature of said water line,
a logic controller able to analyze the acoustic signature and determine whether the acoustic signature is indicative of a water leak,
a water shutoff valve connected to the water line,
a drive unit for opening and closing the water shutoff valve, and
a software package for analysis of the acoustic signature and closing of the water shutoff valve,
wherein the logic controller and software are capable of discriminating between more than one acoustic signature and controlling the water shutoff valve based on inappropriate continuation of any of the plurality of signatures being monitored.

11. The apparatus of claim 10 wherein the logic controller further comprises a manual override.

12. The apparatus of claim 10 further comprising a communications link for notification of closing of the valve.

13. The apparatus of claim 10 further comprising a receiver visual indication of the status of the system.

14. The apparatus of claim 10 further comprising a battery to supply power to said apparatus.

15. The apparatus of claim 14 wherein said battery is rechargeable.

16. The apparatus of claim 10 wherein the software package comprises training subroutines to analyze normal water usage patterns prior to the apparatus being placed in service to detect leaks.

17. The apparatus of claim 10 further comprising feedback from remote sensors, which authorize water flow to occur to an appliance or other outlet.

18. The apparatus of claim 10 where the apparatus monitors and controls water flow to the water main of a house of building.

19. The apparatus of claim 1 further comprising inputs from remote fixtures or appliances in the building or structure that authorize water flow through those remote fixtures of appliances.
